(19) United States
(12) Patent Application Publication
(10) Pub. No.: US 2016/0193746 A1
(43) Pub. Date: Jul. 7, 2016

(54) SLICING DEVICE

(71) Applicants: BOE TECHNOLOGY GROUP CO., LTD., Beijing (CN); Beijing Boe Display Technology Co., Ltd., Beijing (CN)

(72) Inventors: Xinyu Hu, Beijing (CN); Xiaoliang Chu, Beijing (CN); Yongchao Zhang, Beijing (CN); Xinming Duan, Beijing (CN); Qian Liu, Beijing (CN)

(21) Appl. No.: 14/802,081

(22) Filed: Jul. 17, 2015

(30) Foreign Application Priority Data
Jan. 4, 2015 (CN) 201510001891.7

(51) Int. Cl. B26D 7/00; B26D 7/26

(52) U.S. Cl. CPC B26D 7/0006; B26D 7/2614

(57) ABSTRACT

The invention refers to a technical field of display device, and specifically discloses a slicing device. The slicing device includes a base, a mold and a cutting device; therein, an avoiding groove for cooperating with the cutting device is provided on the base, and multiple first supporting rods are fixed on the base; the mold is fixed detachably at a setting position on the base, and the mold has an opening cooperating with the cutting device; the cutting device is assembled slidably on the multiple first supporting rods; therein, each of the first supporting rods is sheathed with a first buffer spring. In the above technical solution, by means of the detachable connection between the mold and the base, when the mold is damaged, the mold can be detached directly, and replaced with a new mold, and the base does not need to be replaced, so that reduces the cost of maintaining the slicing device.

### RELATED APPLICATIONS

The present application claims the benefit of Chinese Patent Application No. 201510001891.7, filed Jan. 4, 2015, the entire disclosure of which is incorporated herein by reference.

### TECHNICAL FIELD

The invention refers to a technical field of manufacturing display device, and more specifically to a slicing device.

### BACKGROUND

Currently, in the industry of TFT-LCD or in the progress of mass producing other electronic product, the chip on film (COF) or flat cable for connecting panel and PCB both originally have dimensions in rolls provided by manufacturer, and is sliced by a device before bonding. For example, in slicing of chip on film in the industry of TFT-LCD, for different sizes or dimensions of product, the dimensions and models of the slicing device for slicing the chip on film are different also.

Moreover, in the progress of existing product producing, a product having a different dimension and model corresponds to a slicing device having one dimension, and the slicing device would be scrapped or returning to the manufacturer if the cutter in the slicing device wears. Therefore, multiple slicing devices need to be prepared for achieving the continuity of producing, which is cost expensive.

### SUMMARY

The invention provides a slicing device, for reducing maintaining cost of the slicing device for chip on film or flat cable, and improving the adaptability of the slicing device.

The invention provides a slicing device, which includes a base, a mold and a cutting device; therein,

An avoiding (anti-collision) groove for cooperating with the cutting device is provided on the base, and multiple first supporting rods are fixed on the base;

The mold is fixed detachably at a setting position on the base, and the mold has an opening cooperating with the cutting device;

The cutting device is assembled slidably on the multiple first supporting rods; therein,

A portion of each of the first supporting rods which is between the base and the cutting device is sheathed with a first buffer spring.

In the above technical solution, by means of the detachable connection between the mold and the base, when the mold is damaged, the mold can be detached directly, and replaced with a new mold, and the base does not need to be replaced, so that reduces the cost of maintaining the slicing device. Besides, by means of the above structure, the slicing device can be replaced with a different mold and cutting device, so as to cutout different sizes of chip on film or flat cables.

Preferably, the base and the mold are connected slidably by cooperation of sliding grooves and sliding rails; and when the mold slides to a setting position, the mold is locked on the base by first threaded connectors. This facilitates positioning during mounting of the mold.

Preferably, further includes, when the mold slides to the setting position, the mold is positioned on the base by at least two positioning rivets. This improves precision during mounting of the mold.

Preferably, the number of the first threaded connectors is six, and the number of the positioning rivets is two, and the six first threaded connectors are disposed at two sides of the opening symmetrically; the two positioning rivets are disposed at two sides of the opening symmetrically. This ensures the mold is exerted force evenly during being fixed, and avoids shifting due to uneven force exerted during being mounted and affecting mounting precision.

Preferably, sliding rails are provided on the mold and sliding grooves are provided on the base, and the sliding grooves are open at one end and closed at the other end. This facilitates mounting and positioning of the mold.

Preferably, the cutting device includes: an upper substrate, a guiding plate and a cutter, therein,

The upper substrate is slidably assembled on the first supporting rods, and multiple second supporting rods which are slidable with respect to the upper substrate are provided through the upper substrate;

The cutter is detachably fixed on the upper substrate, and a cutting portion of the cutter is orientated towards the mold; The guiding plate has a guiding hole cooperating with the cutting portion, and is connected fixedly with the second supporting rods;

Second buffer springs which are sheathed on each of the second supporting rods respectively are provided between the guiding plate and the upper substrate. The detachable structure employed facilitates replacing of the cutter and further reduces the maintaining cost of the slicing device.

Preferably, one end of the cutter which is distant from the cutting portion is a fixing portion, and there is a positioning flange abutted on the upper substrate between the fixing portion and the cutting portion;

A through hole through which the fixing portion passes is provided on the upper substrate; a fixing plate is provided at a side of the upper substrate which departs from the cutter, and the fixing plate is connected fixedly with the fixing portion by second threaded connectors, and connected fixedly with the upper substrate by third threaded connectors. This ensures the positioning precision and firmness during mounting the cutter.

Preferably, multiple guiding rods which cooperate with the guiding plate are provided on the upper substrate, and through holes for cooperating with the guiding rods are provided in the mold. This improves the alignment accuracy between the cutter and the mold.

Preferably, the first supporting rods are threaded connected with the base.

At least two fourth threaded connectors with nuts are further included, therein the fourth threaded connectors are provided through the upper substrate and threaded connected with the base, and the nuts of the fourth threaded connectors are at a side of the upper substrate which departs from the cutter. This improves the stability of the whole device.

The invention further provides a method of producing slicing device, which includes: providing a base, which is provided with an avoiding groove for cooperating with a cutting device; fixing multiple first supporting rods on the base; detachably fixing the mold at a setting position on the base, and the mold has an opening cooperating with the cutting device; assembling slidably the cutting device on the multiple first supporting rods, and sheathing a first buffer spring at a portion of each of the first supporting rods which is between the base and the cutting device.

Preferably, sliding cooperation connection between the base and the mold is realized by sliding grooves provided in the base and sliding rails provided in the mold.

Preferably, the cutting device is provided with an upper substrate, a guiding plate and a cutter, therein, the method further includes slidably assembling the upper substrate on the first supporting rods, and through the upper substrate, providing multiple second supporting rods which are slidable with respect to the upper substrate; detachably fixing the cutter on the upper substrate, and orientating a cutting portion of the cutter towards the mold; the guiding plate has a guiding hole cooperating with the cutting portion, and are connected fixedly with the second supporting rods; sheathing a second buffer spring on a portion of each of the second supporting rods which is between the guiding plate and the upper substrate.

### BRIEF DESCRIPTION OF FIGURES

FIG. 1 is a perspective view of a slicing device provided by an embodiment of the invention;

FIG. 2 is an exploded schematic view of the slicing device provided by the embodiment of the invention;

FIG. 3 is a side view of a cutter provided by the embodiment of the invention.

### LIST OF THE REFERENCE NUMBERS

10: base; 11: groove; 111: sliding groove;

12: positioning rivet; 13: first threaded connector; 20: mold;

21: opening; 30: first supporting rod; 31: first buffer spring;

40: cutting device; 41: upper substrate; 42: cutter

421: cutting portion; 422: positioning flange; 423: fixing portion;

43: guiding plate; 44: guiding rod; 45: fixing plate;

46: second supporting rod; 47: second buffer spring; 48: second threaded connector;

49: third threaded connector; 50: fourth threaded connector.

### DETAIL EMBODIMENTS

In order to reduce maintain cost of slicing device for chip on film or flat cable and improving adaptability of the slicing device, an embodiment of the invention provides a slicing device. In the embodiment of the invention, by means of detachable structure between the mold and the base, the base can be replaced with different molds during usage according to different requirements, so that improves the adaptability of the slicing device. Moreover, upon the mold is damaged, the mold can be detached directly and replaced with a new mold, and replacing a whole set of the slicing device is not needed, so that reduces the maintain cost of the slicing device. In order to make the object, technical solution and advantage of the invention more clear, the invention will be further described in detail below with non-limiting embodiments as examples.

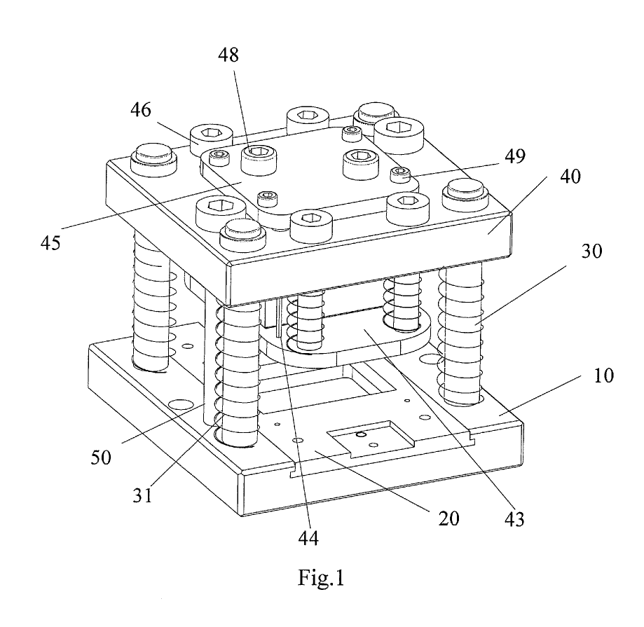

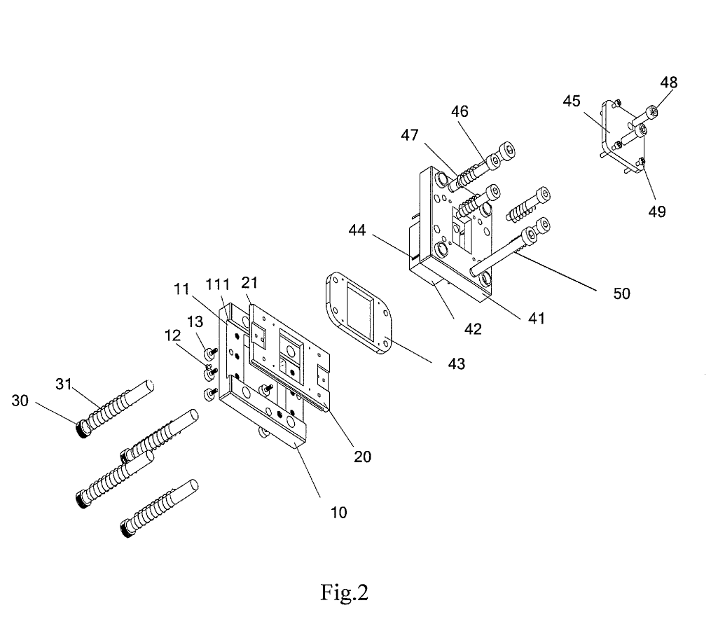

As shown in FIGS. 1 and 2, FIG. 1 shows a structural schematic view of the slicing device provided by the embodiment of the invention; and FIG. 2 shows an exploded schematic view of the slicing device provided by the embodiment of the invention.

The embodiment of the invention provides a slicing device, which includes a base 10, a mold 20, and a cutting device 40; therein,

An avoiding groove for cooperating with the cutting device 40 is provided on the base 10, and multiple first supporting rods 30 are fixed on the base 10;

The mold 20 is fixed detachably at a setting position on the base 10, and the mold 20 has an opening 21 cooperating with the cutting device 40;

The cutting device 40 is assembled slidably on the multiple first supporting rods 30, and has a cutter 42 cooperating with the mold 20; therein,

A portion of each of the first supporting rods 30 which is between the base 10 and the cutting device 40 is sheathed (embraced) with a first buffer spring 31.

In the above specific embodiment, by means of the detachable connection between the mold 20 and the base 10, when the mold 20 is damaged, the mold 20 can be detached directly from the base 10, and replaced with a new mold 20, and the base 10 and other components do not need to be replaced, so that reduces the cost of maintaining the slicing device. Besides, by means of the above structure, the slicing device can be replaced with a different mold 20 and a corresponding cutting device 40, so as to cutout different sizes of chip on film or flat cables.

For facilitating understanding of the slicing device provided by the embodiment of the invention, the slicing device provided by the embodiment of the invention will be described in detail below in conjunction with FIGS. 1 and 2.

During connecting the mold 20 and the base 10, the base 10 and the mold 20 are connected slidably by cooperation of sliding grooves 111 and sliding rails; and when the mold 20 slides to a setting position, the mold 20 is locked on the base 10 by first threaded connectors 13. Specifically, during assembling, a way of sliding assembling is employed between the mold 20 and the base 10, so as to make the mold 20 stably fixed on the base 10, and ensure the opening 21 on the mold 20 and the cutting portion 421 of the cutter 42 being able to cooperate with each other accurately.

In the above sliding assembling, the mold 20 is provided with sliding rails, and the base 10 is provided with sliding grooves 111, and the sliding grooves 111 are open at one end and closed at the other end. Specifically, a groove 11 is provided on the base 10, and the sliding grooves 111 are disposed at opposite sides of the groove 11 symmetrically; when the mold 20 is assembled on the base 10, it will be inserted from the open end of the sliding groove 111; and when the end of the mold 20 is abutted against the closed end of the sliding groove 111, the mold 20 is mounted at a setting position. Moreover, as a preferred solution, when the mold 20 slides to the setting position, the mold 20 is positioned on the base 10 by at least two positioning rivets 12. By positioning and connecting the mold 20 and the base 10 with the provided at least two positioning rivets 12, some errors occurring when assembling will be prevented and ensures the assembling precision between the mold 20 and base 10. After connecting the mold 20 and the base 10 by the positioning rivets 12 (if exist), connecting fixedly the mold and base 10 with the above first threaded connectors 13, so that ensures the reliability of the connection between the mold and the base 10.

Specifically, in the above connection, the number of the first threaded connectors 13 is six, and the number of the positioning rivets 12 is two, and the six first threaded connectors 13 are disposed at two sides of the opening 21 symmetrically; the two positioning rivets 12 are disposed at two sides of the opening 21 symmetrically. This makes the mold 20 to be exerted force evenly, and ensures mounting precision and stability of connection, and avoids position shifting of the mold 20 during connection due to uneven force exerted.

Besides, as a preferred embodiment, the cutter 42 employs a detachable structure, so as to make the cutter 42 when being damaged can be detached for replacing directly, which avoids replacing the whole cutting device 40.

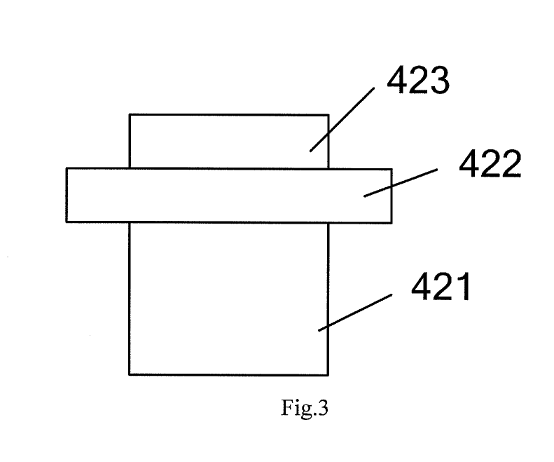

Refers to FIGS. 1, 2 and 3 in combination, therein FIG. 3 is a side view of the cutter 42.

Specifically, the cutting device 40 includes: an upper substrate 41, a guiding plate 43 and a cutter 42, therein,

The upper substrate 41 is slidably assembled on the first supporting rods 30, and multiple second supporting rods 46 which are slidable with respect to the upper substrate 41 are provided through the upper substrate 41;

The cutter 42 is detachably fixed on the upper substrate 41, and a cutting portion 421 of the cutter 42 is orientated towards the mold 20;

The guiding plate 43 has a guiding hole cooperating with the cutting portion 421, and are connected fixedly with the second supporting rods 46;

Second buffer springs 47 which are sheathed on each of the second supporting rods 46 respectively are provided between the guiding plate 43 and the upper substrate 41.

In the above specific embodiment, a detachable fixed connection way is employed between the cutter 42 and the upper substrate 41, which make the cutter 42 after damaged can be detached directly for replacing and the whole cutting device 40 does not need to be replaced. Besides, as a preferred embodiment, if the above structure is employed, when a mold 20 with a different opening 21 is mounted on the base 10, the whole cutting device 40 which cooperates with the mold 20 does not need to be replaced, but only the cutter 42 on the cutting device 40 needs to be detached and replaced for a different cutter 42.

In the above specific connection between the cutter 42 and the upper substrate 41, one end of the cutter 42 which is distant from the cutting portion 421 is a fixing portion 423, and there is a positioning flange 422 abutted on the upper substrate 41 between the fixing portion 423 and the cutting portion 421; a through hole through which the fixing portion passes is provided on the upper substrate 41; a fixing plate 45 is provided at a side of the upper substrate 41 which departs from the cutter 42, and the fixing plate 45 is connected fixedly with the fixing portion 423 by second threaded connectors 48, and connected fixedly with the upper substrate 41 by third threaded connectors 49. Specifically, by abutting the positioning flange 422 of the cutter 42 on the upper substrate 41, and connecting the fixing plate 45 and the fixing portion 423, the cutter 42 can be stably fixed on the upper substrate 41. Meanwhile, the cooperation of the set through hole and the fixing portion 423 ensures the positioning precision of the cutter 42 when being mounted, and ensures the cooperation precision between the cutter 42 after mounted and the mold 20. In the specific connection, the fixing plate 45 and the fixing portion 423 are fixed by the second threaded connectors 48; besides, the fixing plate 45 and the upper substrate 41 are positioned by third threaded connectors 49, so as to ensure the stability of the connection between the cutter 42 and the upper substrate 41, and avoid shaking of the cutter 42 after being fixed.

Moreover, in order to ensure the cooperation precision between the cutter 42 and the mold 20, preferably, multiple guiding rods 44 which cooperate with the guiding plate 43 are provided on the upper substrate 41, and through holes for cooperating with the guiding rods 44 are provided in the mold 20. Therefore, in operation, before the cutter 42 is depressed into the opening 21 of the mold 20, the guiding rods 44 are inserted into the through holes of the mold 20, which ensures the moving direction of the cutting portion 421 of the cutter 42, and improves the cooperation precision between the cutter 42 and the mold 20.

In the slicing device provided in the above embodiment, the first supporting rods 30 are threaded connected with the base 10; at least two fourth threaded connectors 50 with nuts are further included, therein the fourth threaded connectors 50 are provided through the upper substrate 41 slidably and threaded connected with the base 10, and the nuts of the fourth threaded connectors 50 are at a side of the upper substrate 41 which departs from the cutter 42. The base 10 and the upper substrate 41 are limited in horizontal dimension by the fourth threaded connectors 50, so that the base 10 and the upper substrate 41 can not shift horizontally with respect to each other, which avoids the upper substrate 41 slipping out of the first supporting rods 30.

For facilitating understanding to the slicing device provided by the above specific embodiments, the operational principle thereof will be described in detail blow in conjunction with FIGS. 1 and 2.

As shown in FIG. 1, the chip on film is placed over the mold 20, and at this time, the cutting device 40 is depressed, and the first buffer springs 31 are compressed, and the cutting device 40 descends as a whole; then the guiding plate 43 contacts with the mold 20, and the cutting device 40 is depressed continuously, and at this time, the second buffer springs 47 are compressed; then the guiding rods 44 penetrate into the through holes of the mold 20 for guiding, and the cutter 42 continuously descends and cuts the chip on film or flat cable, and after cutting, the guiding device 40 returns to original position under action of the first buffer springs 31, and the guiding plate 43 and the cutter 42 return to original positions under action of the second buffer springs 47. It is to be noted that, the slicing device of the invention not only applies to cutting of the chip on film or flat cables, and applies to cutting of other similar sheet or film-shaped material.

Obviously, the skilled in the art can make various amendments and variations to the invention without departing from the sprite and scope of the invention. As such, in case the amendments and variations to the invention belong to the scope of the claims and their equivalents of this invention, the invention is intended to include these amendments and variations.

In the description of the present application, it is understood that the terms used for indicating the orientations or locations, such as “upper”, “lower”, “inner” and “outer” and so on are based on the orientations or locations shown in the drawings, only for the purpose of facilitating and simplifying the description of the application, rather than indicating or implying that the devices or elements in question have to have specific originations or be operated and constructed in specific originations, which thus cannot be construed to limit the present application. Although in the method claims, various steps are shown in some order, these steps do not necessarily be performed in the order listed, instead can be performed in a reverse or parallel way.

Wording “include” does not exclude the presence of other elements or steps which are not listed in the claims. The wording “a” or “an” ahead of an element does not exclude the presence of a plurality of such elements. The mere fact that certain measures are recited in mutually different dependent claims does not indicate that a combination of these measures cannot be used to advantage. Any reference signs in the claims should not be construed to limit scopes.

1. A slicing device which includes: a base, a mold and a cutting device; wherein,
an avoiding groove for cooperating with the cutting device is provided on the base, and multiple first supporting rods are fixed on the base;
the mold is fixed detachably at a setting position on the base, and the mold has an opening cooperating with the cutting device;
the cutting device is assembled slidably on the multiple first supporting rods; wherein,
a portion of each of the first supporting rods which is between the base and the cutting device is sheathed with a first buffer spring.

2. The slicing device of claim 1, wherein the base and the mold are connected slidably by cooperation of sliding grooves and sliding rails; and when the mold slides to a setting position, the mold is locked on the base by first threaded connectors.

3. The slicing device of claim 2, wherein when the mold slides to the setting position, the mold is positioned on the base by at least two positioning rivets.

4. The slicing device of claim 3, wherein the number of the first threaded connectors is six, and the number of the positioning rivets is two, and the six first threaded connectors are disposed at two sides of the opening symmetrically; the two positioning rivets are disposed at two sides of the opening symmetrically.

5. The slicing device of claim 2, wherein the sliding rails are provided on the mold and the sliding grooves are provided on the base, and the sliding grooves are open at one end and closed at the other end.

6. The slicing device of claim 1, wherein the cutting device includes: an upper substrate, a guiding plate and a cutter, wherein,
the upper substrate is slidably assembled on the first supporting rods, and multiple second supporting rods which are slidable with respect to the upper substrate are provided through the upper substrate;
the cutter is detachably fixed on the upper substrate, and a cutting portion of the cutter is orientated towards the mold;
the guiding plate has a guiding hole cooperating with the cutting portion, and is connected fixedly with the second supporting rods;
second buffer springs which are sheathed on each of the second supporting rods respectively are provided between the guiding plate and the upper substrate.

7. The slicing device of claim 6, wherein, one end of the cutter which is distant from the cutting portion is a fixing portion, and there is a positioning flange abutted on the upper substrate between the fixing portion and the cutting portion;
a through hole through which the fixing portion passes is provided on the upper substrate; a fixing plate is provided at a side of the upper substrate which departs from the cutter, and the fixing plate is connected fixedly with the fixing portion by second threaded connectors, and connected fixedly with the upper substrate by third threaded connectors.

8. The slicing device of claim 7, wherein, multiple guiding rods which cooperate with the guiding plate are provided on the upper substrate, and through holes for cooperating with the guiding rods are provided in the mold.

9. The slicing device of claim 8, wherein, the first supporting rods are threaded connected with the base;
and the slicing device further includes at least two fourth threaded connectors with nuts, wherein the fourth threaded connectors are provided through the upper substrate slidably and threaded connected with the base, and the nuts of the fourth threaded connectors are at a side of the upper substrate which departs from the cutter.

10. The slicing device of claim 1, wherein the slicing device is used for cutting chip on film or flat cable.

11. A method of producing a slicing device which includes:
providing a base, which is provided with an avoiding groove for cooperating with a cutting device;
fixing multiple first supporting rods on the base;
detachably fixing the mold at a setting position on the base, and the mold has an opening cooperating with the cutting device;
assembling slidably the cutting device on the multiple first supporting rods, and sheathing a first buffer spring at a portion of each of the first supporting rods which is between the base and the cutting device.

12. The method of claim 11, wherein sliding cooperation connection between the base and the mold is realized by sliding grooves provided in the base and sliding rails provided in the mold.

13. The method of claim 11, wherein the cutting device is provided with an upper substrate, a guiding plate and a cutter, wherein the method further includes:
slidably assembling the upper substrate on the first supporting rods, and through the upper substrate, providing multiple second supporting rods which are slidable with respect to the upper substrate;
detachably fixing the cutter on the upper substrate, and orientating a cutting portion of the cutter towards the mold;
the guiding plate has a guiding hole cooperating with the cutting portion, and are connected fixedly with the second supporting rods;
sheathing a second buffer spring on a portion of each of the second supporting rods which is between the guiding plate and the upper substrate.
